(19) United States
(12) Patent Application Publication
(10) Pub. No.: US 2008/0012287 A1
(43) Pub. Date: Jan. 17, 2008

(54) Luminescent/fluorescent label for a beverage container and method of making same

(76) Inventor: R. Richard Saxby, Beverly Hills, CA (US)

Correspondence Address: QUINN EMANUEL;KODA & ANDROLIA, 865 S. FIGUEROA STREET, 10TH FLOOR, LOS ANGELES, CA, 90017, US

(21) Appl. No.: 11/475,435

(22) Filed: Jun. 27, 2006

Related U.S. Application Data
(60) Provisional application No. 60/694,739, filed on Jun. 28, 2005.

(51) Int. Cl. B42D 15/00

(52) U.S. Cl. 283/81

(57) ABSTRACT

A label emissive layer for a container including a substrate, indicia printed on the substrate and a layer of photostorage and light emissive material provided on the substrate over the printed indicia. The process includes the steps of mixing a photostorage and light emissive material colored with bright fluorescents with an ink to form a light emissive ink, printing indicia on a heat shrinkable substrate, applying a layer of light emissive ink over the indicia, curing the layer of light emissive ink and applying a layer of optical brightener over the layer of light emissive ink or directly on the container itself before the label is applied.

### BACKGROUND OF THE INVENTION

1. Field of Invention

This invention relates to labels for beverage containers and methods of making same which contain colored photostorage and light emissive materials.

2. Prior Art

In there prior art, there exists a plurality of ways of making labels for containers, particularly beverage containers. However, such prior art beverage container labels and methods of making same result in a label which at best includes printing in different colors and which provides no attraction to a customer or consumer in low level light and/or dark conditions.

### SUMMARY OF THE INVENTION

Accordingly, it is the general objection of the present invention to overcome the deficiencies of the prior art.

In particular, it is the object of the present invention to provide a label for containers in different colors and which provides attraction to a customer or consumer in low level light and/or dark conditions.

It is still another object of the present invention to provide a label and method of making same which glows in the dark.

The label for the container includes a heat shrinkable substrate of transparent or translucent material, indicia printed on the substrate in translucent or opaque ink, a layer of photostorage and light emissive material provided on the substrate over the printed material and a layer of white optical brightener provided on the layer of photostorage and light emissive material. The optical brightener can also be applied to the beverage container as an alternative method.

The light emitting label is made by mixing a photostorage emissive material with a translucent or transparent ink to form a light emissive ink, printing indicia on a heat shrinkable substrate, applying a layer of the light emissive ink over the indicia and providing a layer of white optical brightener over the layer of light emissive ink after the layer of light emissive ink is cured.

### BRIEF DESCRIPTION OF THE DRAWINGS

FIG. 1 is a flow diagram of the present invention.

FIG. 2 is a flow diagram of flexo-rotary screen process; and

FIG. 3 is a flow diagram for milling/grinding process for the colorant.

### DETAILED DESCRIPTION OF THE INVENTION

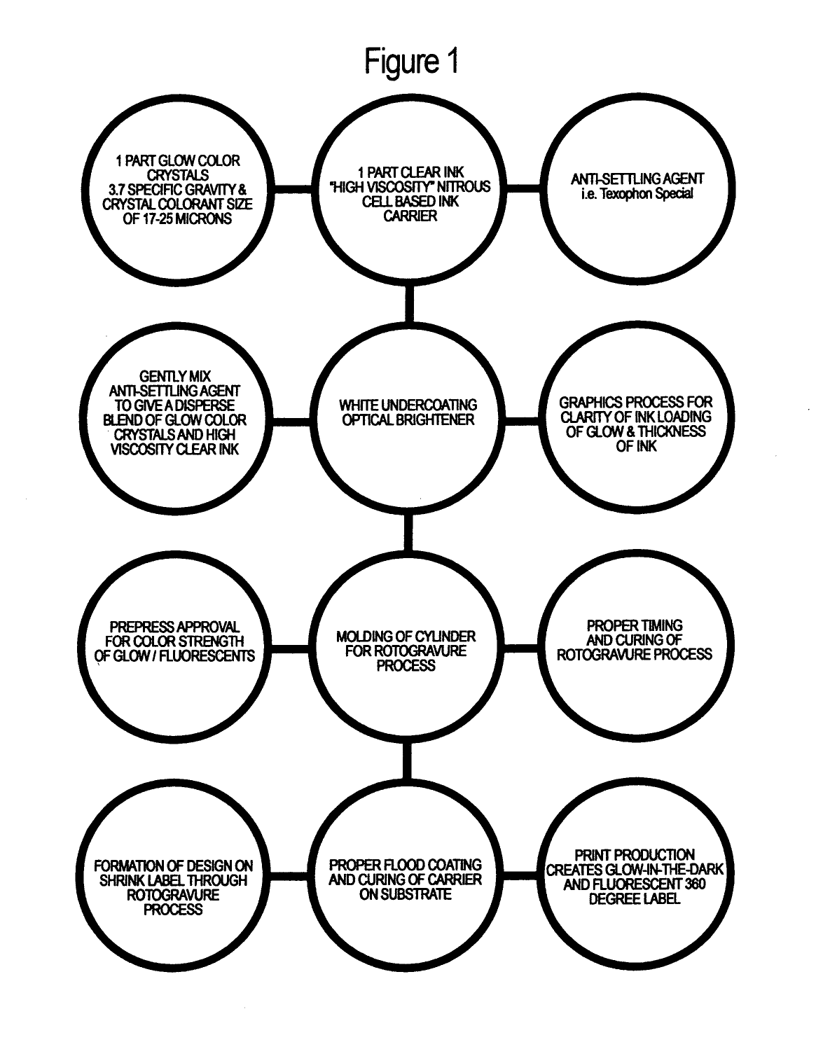

Referring to FIG. 1, the beverage container label and method of making same of the present invention are created utilizing colored photostorage and light emissive materials which are luminescent and/or florescent. In particular, such colored photostorage and light emissive materials should have high and long light emissive properties so as to have high glow brightness. Suitable luminescent materials include materials such as are disclosed in U.S. Pat. Nos. 5,376,303 and 5,885,483, and materials which are a combination of a luminescent and fluorescent colorant such as is disclosed in U.S. Pat. No. 6,177,029.

Such colored photostorage and light emissive materials are typically made in crystalline or powdered form and for use in the present invention must be converted into an ink which can be utilized for printing on the label. Typically, the ink utilized for printing is made by combining a colored photostorage and light emissive material with a clear or translucent ink. Preferably, the loading ratio by weight is one part clear ink to one part colored photostorage and light emissive material. In addition, such colored photostorage and light emissive materials are provided in a powdered or crystalline form of a size of 17 to 25 microns through a fine mesh, preferably about 500 mesh. Materials are provided in a multitude of florescent colors such as green, orange, blue, yellow, gold, and red. Such different colored materials can also be mixed together in various ratios to produce other colors such as a blue green which comprises 70% blue material and 30% green, and so on.

When blending the ink for printing the labels of the present invention, it is recommended that a clear or a translucent ink be selected which is sufficient to suspend colored photostorage and light emissive material. The colored photostorage and light emissive material is relatively heavy and has a specific gravity of about 3.7. In addition, when blending the colored photostorage and light emissive material with the clear or translucent ink, it should be done gently and mills and high speed mixers should be used with discretion so as to not damage or reduce the effectiveness of the colored photostorage and light emissive materials.

Once the ink containing the colored photostorage and light emissive materials is created, the pattern, image, and/or design of the label may be printed on a film used for labels in a printing process. A rotogravure process can be utilized because of its 360° marking capability that delivers vibrant, photographic images. The rotogravure process is an intaglio method of printing, meaning that the images, designs, text and/or pictures are engraved into the printing cylinder. In particular, of the rotogravure process utilizes a photographic process in which positives are made from the negatives and the images are transferred to the printing surface by use of a carbon tissue covered with light sensitive gelatin which is put on the printing cylinder. The gelatin hardens based on the amount of light that passes through the positives of the photographed image. The printing cylinder is then bathed in acid which eats through the gelatin. In the printing process, the deepest cells retain the most ink and the darkest tones. However, this process requires about seven cylinders.

The label is printed in colors on a suitable film utilized for beverage containers, and preferably the film is a heat shrinkable material so that once the label is printed, it can be easily applied to standard containers utilizing equipment well known to those of ordinary skill in the art. After the label is applied to the containers, if it is exposed to light, whether the light is natural sunlight or light from incandescent or florescent lamps, the light is stored in the colored photostorage and light emissive material to be readmitted for long periods of time, up to about 14 hours, after the light is removed. In addition, since the material contains florescent colorants, upon the application of ultraviolet light or blacklight, the label will glow brightly and continue to grow so long as being exposed to ultraviolet light or blacklight, such as found in discos, bars, and clubs.

In addition, if the label of the present invention is applied to a standard aluminum can, the polished and/or reflective surface of the aluminum container will reflect the emitted light during the emissive process and will contribute to the brightness. However, if it is desired to make the image brighter, an optical brightener, such as one in opaque white, can be applied over the printed label on the inside of the film between the container and the film and the brightness can be improved by as much as 40%. Still further, the brightness of the light emitted by the label can be improved or increased by using a clear ink with more clarity, increasing the load of the material in the clear ink and increasing the thickness of the ink printed on the label.

In addition, a reverse flexo-screen printing process can be utilized to print labels. In this process, fluorescent pantones such as neon yellow powder pigment, and neon orange powder pigments may also be utilized as well as any of the fluorescent pantones available in the market today from various manufacturers know in this industry. In this reverse flexo-screen printing, all is printed on a clear or translucent substrate which is the same heat shrinkable film used in the above described rotogravure process. Such a heat shrinking material is a PVC substrate.

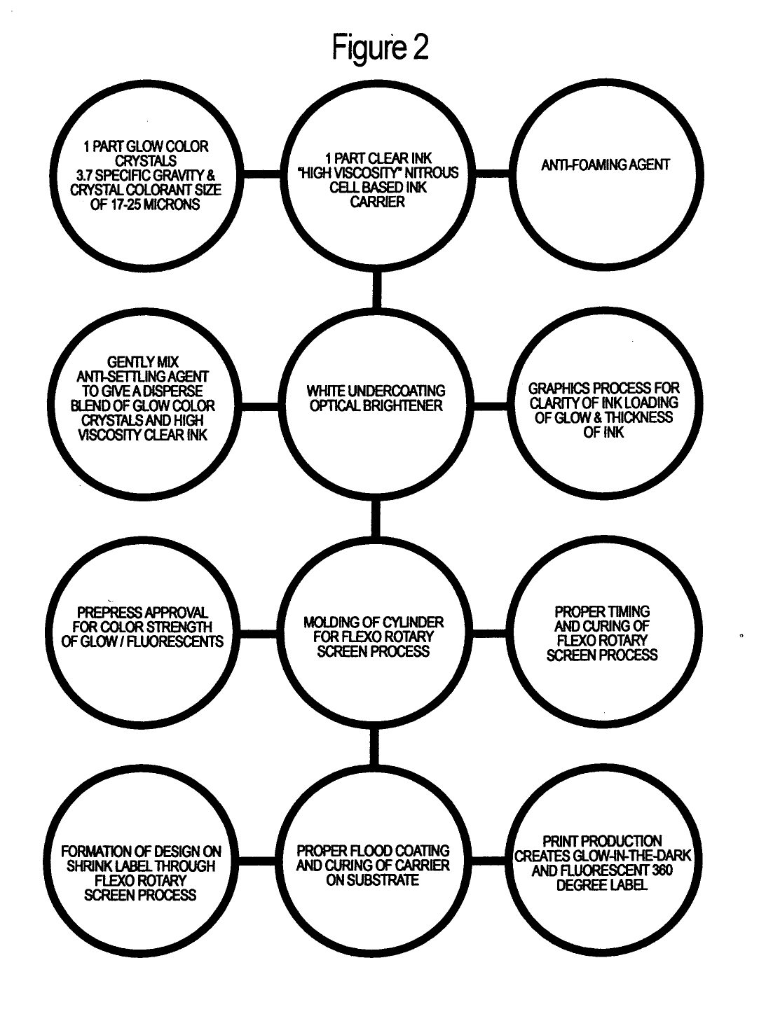

The luminescent/fluorescent ink used in the process comprises the crystal colorant mixed together with a clear UV cure ink. The luminescent ink is preferably made by gently mixing 50% colorant and 50% high viscous clear ink. While this represents the preferred ratios, it would also be possible to use the colorant in the amount from 20%-50% and the ink in 80%-50%. During the reverse flexo-screen printing on the PVC substrate, a screen is utilized. The fineness of the screen ranges from 125/20 screen to a 125/30 screen. The reverse flexo rotary screen process is illustrated in FIG. 2 and in this process the large print or graphic is first printed on the substrate then UV cured and chilled through a drum press to neutralize. Next, any fine printing or graphic is printed on the substrate utilizing an ink the same as or similar to one utilized to print the larger printing. Then, in one or more passes, the crystal coloring mixed with the carrier or ink is applied to the substrate using a 125/20 screen. At any and all stages of any ink lay down, including the final tint coat of white optical brightener, the UV lamp and chilling drum process to cure and neutralize the ink on the substrate is utilized. In some applications, this tint coat may not be required.

After sitting overnight, the substrate is then cut and sealed into labels, or put on spools, which are shrink wrapped over containers preferably through an automated application system well known in the art.

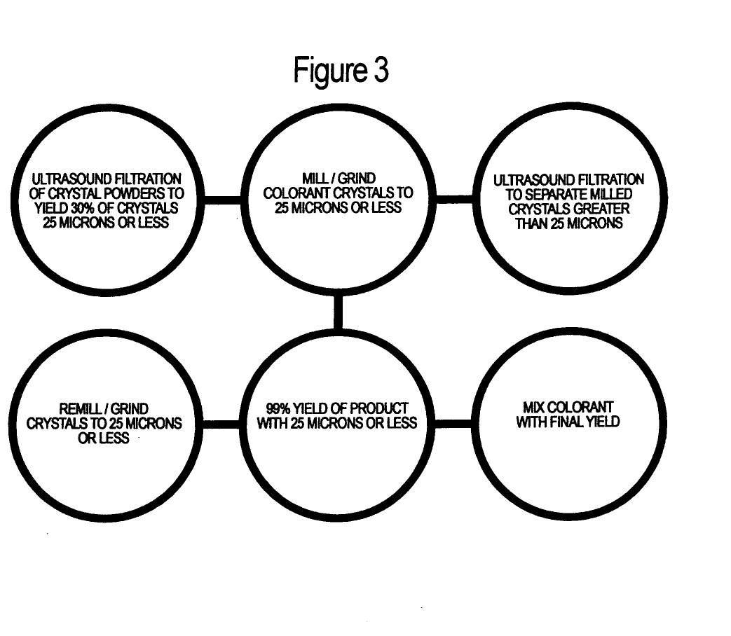

It should also be pointed out that in a reverse flexo rotary screen printing process, the fineness of the color of the crystals is of even more import and can be no greater than 25 microns to fit through a very fine mesh such as 500 mesh. While it is possible to order crystals in this size, there is always some variation. As a result and illustrated in FIG. 3, the crystals are passed through a process to ensure that the all of the crystals are less than or equal to 25 microns. In particular, the crystal are first passed through an ultrasonic filter before grinding to separate out those crystals already 25 microns or less. About 30% are 25 microns or less and doing this separation first before grinding will result in greater brightness. The separated crystals are put into a preferably ceramic mill for grinding to 25 microns or less. The resultant is then again applied to an ultrasonic filter to separate out those crystals greater than 25 microns. Typically, the amount of ceramic milled crystals greater than 25 microns is about 18%. The separated crystals are then remilled by grinding them again until they are 25 microns or less. Similarly, the resultant from this ceramic remilling is also separated so that any crystals greater than 25 microns are then remilled again and this process continues until all of the crystals utilized in the colorant are 25 microns or less, preferably 17 to 25 microns.

In mixing the carrier ink and the colorant, it is sometimes required to utilize other agents. These other agents include anti-settling and defoaming agents, solvents and extenders. However, which one of these agents is utilized with any particular ink, process or coloring crystals is selected based upon the needs of the process and the printing desired.

While the present invention provides a distinctive label which not only glows in low light conditions or the dark or under ultraviolet radiation (black light) for long periods of time, it has the additional advantage that the colored photostorage and light emissive material which consists of a luminescent material and a fluorescent colorant allows the label to be printed in colors which appear substantially the same color in natural light and when glowing in low light, the dark, or under ultraviolet light.

While the present invention has been described in terms of the label which has been applied to a beverage container, it should be apparent to one of ordinary skill in the art that the present invention could be applied to bags and other types of containers for other food or pharmaceutical products such as potato chips, peanuts, pills, etc.

1. A light emissive label for a container comprising:
a substrate;
indicia printed on the substrate;
a layer of photostorage and light emissive material provided on said substrate over said printed indicia.

2. The label according to claim 1 wherein the substrate is transparent or translucent.

3. The label according to claim 2 wherein said substrate is a heat shrinkable material.

4. The label according to claim 3 wherein said substrate is PVC.

5. The label according to claim 1 wherein the indicia includes letters and graphics.

6. The label according to claim 5 wherein the indicia is printed with translucent or opaque ink.

7. The label according to claim 4 wherein the indicia comprises letter and graphics.

8. The label according to claim 7 further comprising a layer of optical brightener on said layer of photostorage material or container.

9. The label according to claim 8 wherein said photostorage material is selected from the group consisting of luminescent and fluorescent materials and mixtures thereof and a translucent or transparent ink.

10. The label according to claim 9 wherein the photostorage material is a colorant.

11. The process for making a light emitting label comprising:
mixing a photostorage and light emissive material with a translucent or transparent ink to form a light emissive ink;
printing indicia on a heat shrinkable substrate; and
applying a layer of said light emissive ink over said indicia.

12. The process according to claim 11 wherein said photostorage and light emissive material is a crystal of a size of less than or equal to 25 microns through 500 mesh.

13. The process according to claim 12 wherein said layer of said light emissive ink is applied use a reverse flexo-rotary screen process.

14. The process according to claim 13 wherein said reverse flexo-rotary screen process is preformed with a 125/20 screen.

15. The process according to claim 14 wherein the photostorage and light emissive material is selected from the group consisting of luminescent and fluorescent materials and mixtures thereof.

16. The process according to claim 15 wherein the photostorage and light emissive material is mixed gently with said ink in equal parts.

17. The process according to claim 16 further comprising a layer of white optical brightener applied to said layer of light emissive ink or a container.

18. The process according to claim 12 comprising:
processing said photostorage and light emissive material to be substantially all of a size of 25 microns or less, said process comprising:
(a) separating out crystals having a size greater than 25 microns;
(b) grinding or milling said separated crystals;
(c) separating out separating out milled crystals having a size greater than 25 microns;
(d) regrinding or milling the resultant having a size greater than 25 microns; and
(e) repeating steps (b) and (c) until substantially all of the material is of a size of 25 microns or less through 500 mesh.

19. The process according to claim 18 where step (b) is performed using an ultrasonic filter.

20. The process according to claim 17 wherein the ink is UV curable.

21. The process according to claim 20 wherein the layer of light emissive ink is cured by exposing it to UV light and chilled before said layer of white optical brightener is applied.

22. The process according to claim 18 wherein the milling is done with a ceramic miller.
